(19) United States
(12) Patent Application Publication
(10) Pub. No.: US 2013/0238417 A1
(43) Pub. Date: Sep. 12, 2013

(54) System for Advertising Revenue Generation

(71) Applicant: Raymond J. Frelk, JR., Franklin, WI (US)

(72) Inventor: Raymond J. Frelk, JR., Franklin, WI (US)

(73) Assignee: R J FRELK AND ASSOCIATES, LLC, Franklin, WI (US)

(21) Appl. No.: 13/823,634

(22) PCT Filed: Sep. 15, 2011
(86) PCT No.: PCT/US11/51793

§ 371 Date: May 29, 2013

Related U.S. Application Data
(60) Provisional application No. 61/383,177, filed on Sep. 15, 2010.

(51) Int. Cl. G06Q 30/02

(52) U.S. Cl. CPC G06Q 30/0265
USPC 705/14.36; 705/14.56

(57) ABSTRACT

The present invention is an in flight entertainment system (IFE system) for generating additional revenue that a) communicates advertising content along with some requested act for that advertisement to an airline passenger; b) records information about the performance of the requested act by the passenger and c) rewards the passenger with some type incentive for performing the requested act while allowing for an additional revenue to be generated from the advertiser who pays an additional fee for the effectiveness of the advertisement in generating the passenger's requested act performance.

### BACKGROUND OF THE INVENTION

1. Field of the Invention

The present invention pertains to a system for generating advertising revenue, and more specifically as this relates to in flight entertainment systems (IFE systems). More particularly, the invention preferably includes an IFE system that generates additional revenue from advertisers whose advertisements appear on the IFE system when passengers view the advertisements, redeem discounts, or otherwise provide information or perform acts requested by advertisements on the IFE system.

2. Discussion of the Related Art IFE systems are on many modern aircraft for the entertainment and education of airline passengers. The IFE systems provide diversions for the passengers while on board the aircraft, usually in the form of audio, such as music or spoken word programs. The IFE system also provides video programs, such as movies, television shows, and video games. IFE systems typically comprise a video viewing system such as a movie screen or a personal video monitor in the seatback in front of the passenger. In addition, audio is generally provided with personal headphones.

Airlines and others use the IFE systems as revenue generators by providing for paid advertising from other business entities (advertisers). The advertisers pay for the display or playback of their advertisements on the airline's IFE systems, and passengers view or are otherwise exposed to this advertising content while on board the aircraft.

In addition, advertisers may target certain advertisements to a given audience of passengers. For example, passengers travelling to Jamaica may view advertisements for Jamaican coffee or rum that they can buy while in Jamaica. Returning passengers may view advertisements for duty-free goods that may be purchased before they deplane.

However, what is needed is a way for the advertiser to track the effectiveness of their paid advertising and get a return on their investment, and a way for airlines to generate additional revenue from the advertisers.

### SUMMARY OF THE INVENTION

The present invention relates to a revenue generation system that is preferably connected to an IFE system. The inventive system preferably a) communicates advertising content along with some requested acts (such as redemption of a coupon during a purchase) to an airline passenger, b) requires that the requested act be performed in a subsequent transaction with the advertiser, and c) rewards the passenger with some type of bonus, discount, or other incentive. The system also preferably simultaneously generates additional revenue for the airline from the advertiser who pays an additional fee for “measured” effectiveness of the advertisement, e.g., one that generates an actual transaction between the passenger and the advertiser. Thus, the incentive system tracks the effectiveness of the advertising in terms of transactions generated, such as when a passenger purchases advertised goods from the advertiser.

Specifically, the present invention preferably provides an IFE system for an aircraft having an audio visual system on the aircraft including a video device for presentation of a video program and an audio device for presentation of an audio program. A control is provided for choosing the video and audio programs for presentation to a passenger. An advertisement is presented to the passenger along with the presentation of the chosen audio or video program via a media server having a processor and a storage unit that contains the advertisement along with other audio and video programs. A communication channel on board the aircraft transmits the audio and video programs from the media server to the audio visual system. The advertisement requests that the passenger perform an act presented in the advertisement. A recording system in communication with the IFE system captures a record comprising the passenger identity, the identity of the advertisement presented to the passenger, the requested act information, and the information about the performance of the requested act. A database then stores the record for future use.

It is thus a feature of at least one embodiment of the invention to provide improved analysis of the effectiveness of the advertisements in eliciting a requested act from an airline passenger.

The IFE system may further include an additional fee that is assessed to an advertiser for the advertisement presented when the passenger performs the requested act.

Therefore, it is a feature of at least one embodiment of the invention to provide another revenue stream based on the effectiveness of the advertisements in eliciting a requested act from an airline passenger.

The IFE system may also have an incentive given to the passenger who is presented the advertisement and performs the requested act.

The IFE system may include the passenger presenting identifying information in the performance of a post-deplaning requested act. The system allows the passenger to perform the requested act after leaving the aircraft, yet still tracks the passenger's response to the advertisement.

It should be noted that although a system for an IFE system is described, the system will essentially be the same whether in an aircraft, airport lounge, train, bus terminal, hotel room, or any other location where the inventive software is accessible. For example, hardware components that would be desirable in order for the system to operate include:
A wireless local area network (WLAN) composed of wireless access points (typically an IEEE 802.11 g/n system) to provide access to network devices (e.g., laptops, smartphones, tablets, etc).
A wired network switch and router to provide connections from the wireless access points to the media content servers (e.g., to allow customers to view content) or to the internet (e.g., outside of the aircraft).
Media content/web servers, database servers, billing servers to connect via wired Ethernet to the network in order to serve media content (video and or audio), track user data and interactions, and create both billing and advertising reports for the advertisers and the system supplier.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a perspective view of an IFE system of the present invention;

FIG. 2 is a schematic of the IFE system of the present invention showing external computer network connections;

FIG. 3 is a schematic of another embodiment of the present invention showing external computer network connections; and

FIG. 4 is a flow chart of a method of revenue generation of the present invention.

In describing the preferred embodiments of the invention which are illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “communicates”, or terms similar thereto are often used. They are not limited to direct communication but include communication through other elements where such communication is recognized as being equivalent by those skilled in the art.

Further, before any embodiments of the invention are explained in detail, it is to be understood that the invention is capable of other embodiments and of being practiced or of being carried out in various ways. Also, it is to be understood that the phraseology and terminology used herein is for the purpose of description and should not be regarded as limiting. The use of “including,” “comprising”, “at least one of”, or “having” and variations thereof herein is meant to encompass the items listed thereafter and equivalents thereof as well as additional items.

### DESCRIPTION OF PREFERRED EMBODIMENTS

The present invention and the various features and advantageous details thereof are explained more fully with reference to the non-limiting embodiments described in detail in the following description.

Note that the detailed description that follows the drawings, which are used, do not show all the details of every system described, but only certain features of the invention that aid in describing the invention. One skilled in the art will see the benefits of this new invention and know of all the other methods of construction and design.

### 1. System Overview

The present invention relates to a system for generating advertising revenue, preferably an IFE system for an aircraft that generates additional advertising revenue based on the responses of the viewing airline passengers. Briefly, this is accomplished by providing a closed-loop system wherein an advertisement, having some identifier, is presented to the passenger (usually in video, but also in audible form). The passenger then performs a transaction with the advertiser wherein the identifier is used. This allows the advertiser to track the effectiveness of the advertisement. For this information, an additional charge is levied to the advertiser by the airline.

2. Detailed Description of Preferred Embodiments

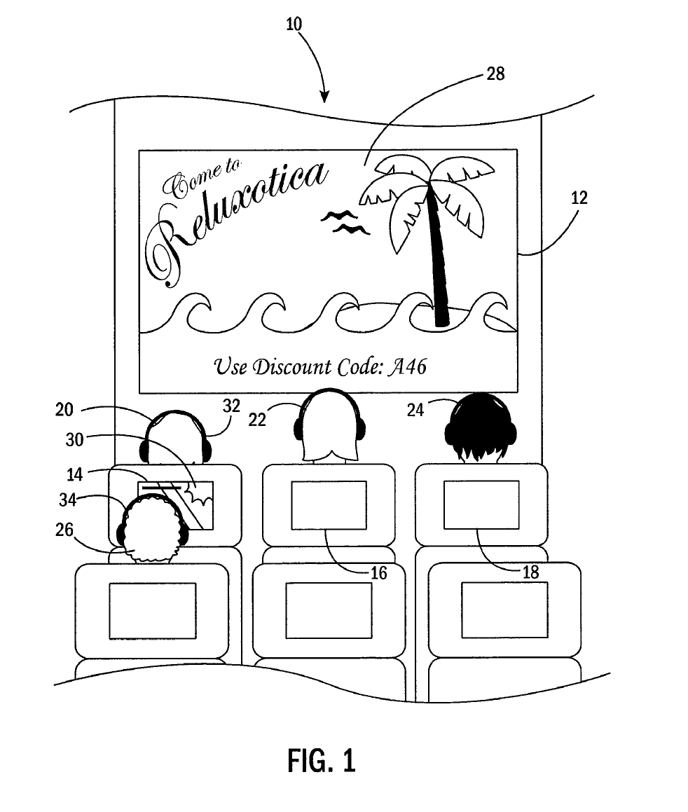

Various embodiments of the present invention are shown in FIGS. 1-4, which are described in additional detail below.

Referring now to FIG. 1, a preferred embodiment of the system 10 of the present invention is shown having visible and audible audio visual systems 12, 14, 16, 18. The system 10, preferably IFE system, may have an audio-visual system that is a projector 12, a television, a personal video screen 14, or any number of systems that connect via a wireless LAN /WLAN or cellular connection such as a personal computer, a laptop, a smart phone, (e.g., I-Phone®, Droid®), tablet computer, or other portable computing device.

Still referring to FIG. 1, passengers on board an aircraft 20, 22, 24 are presented with an advertisement having audio on a projection screen 28, while passenger 26 is viewing a video program with audio on personal video screen 30. The multiple audio visual systems are thus capable of displaying different programs and advertising, such as program 30 that is selected by the passenger 26. The passengers 20, 26 are also being presented audio on headphones 32, 34.

As mentioned, one embodiment of the IFE system provides for various portable computing devices to serve the programs to the passenger realizing a more flexible and easy-to-use system.

The IFE system 10 may present a requested act which is to be performed by the passenger pre-deplaning such as buying an item on the aircraft. Alternatively, the passenger may be asked to perform the requested act post-deplaning. For example, the advertisement 28 on system 12 is displaying the requested act: “Come to Reluxotica” and “Use Discount Code: A46.” A passenger would perform the requested act by deplaning, travelling to Reluxotica, and redeeming discount code A46.

In one preferred embodiment, the discount code or offer could be emailed to the passenger where he would present it to the advertiser for redemption. Upon redemption, the advertiser would notify the IFE systems that the coupon has been redeemed. These redemptions could trigger additional mileage or points being added to the customer's frequent flyer account, additional advertising revenue for the airline, and additional bonuses for the passenger, etc.

In one embodiment, the IFE system 10 allows for the passenger to perform the requested act while still on board the aircraft. Additionally, the passenger may perform the requested act after leaving the aircraft. Thus, the IFE system 10 may track the effectiveness of the advertisements 28, 30 while the passenger is on board and after they leave the aircraft.

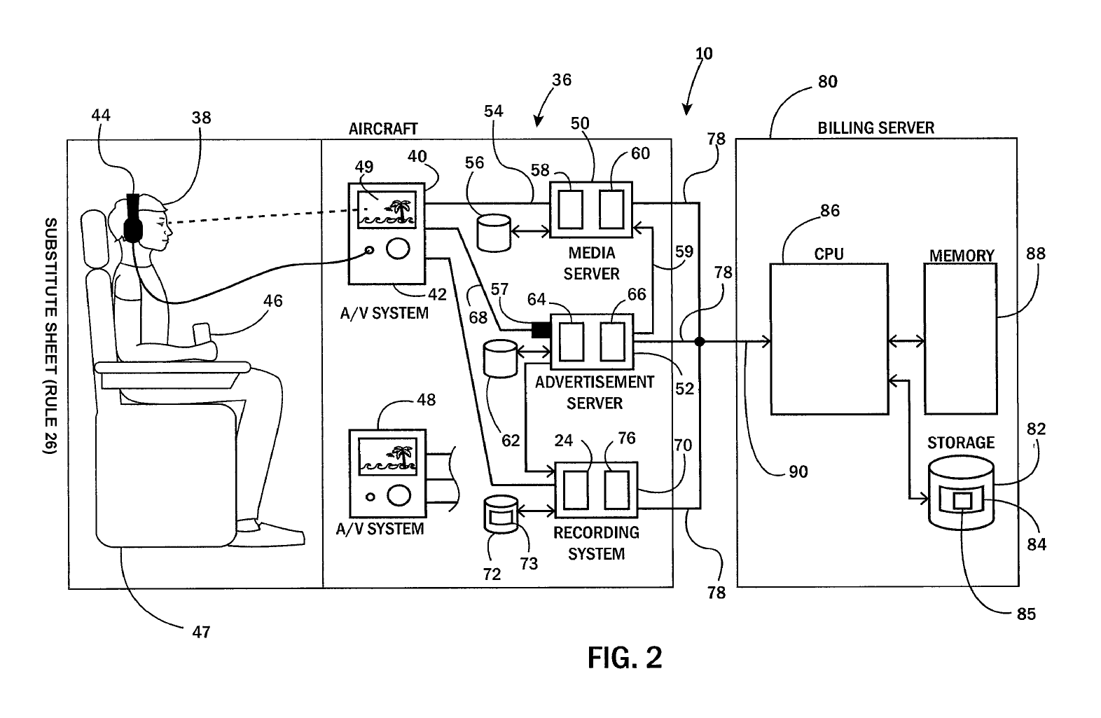

Now referring to FIG. 2, the IFE system 10 includes an aircraft 36 having a passenger 38 viewing audio visual system 40 having a video device 42 and an audio device 44. The passenger may also have a control unit 46 for selecting the programs and controlling other audio visual system parameters such as volume and brightness.

The audio and video programs for the audio visual systems 42, 48 are preferably provided by a media server 50 and an advertisement server 52.

The media server 50 has a communication channel 54 connected to the audio visual system 40 (e.g., via WLAN to a portable computing device). Again, the system may be wired or wireless. The media server 50 also includes a storage device such as hard drive 56 for storing the audio and video programs. The media server also has a processor 58 and a memory 60. The memory 60 may have a stored executable program or other data. For example, the media server 50 responds to signals from controller 46 manipulated by passenger 38. The passenger 38 may select a particular program 49 which causes the media server 50 to stream the content over communication channel 54 to audio visual system 40.

Similarly, the IFE system 10 has an advertisement server 52 which streams advertising to an audio visual system 40, 48. The advertisement server 52 has a processor 64, storage unit 62, and a communication channel 68 for transmitting the advertisement from the advertisement server 52 to the audio visual system 40, 48. The communication channel 68 may be wired or wireless. The advertisement server may also have a device 57 for insertion of the advertising during, substantially around, or within the presentation of the selected audio or video program. The advertising server may include a control 59 for the presentation video and audio programs of the media server. The control may allow the suspension of a program while playing the advertising or it may allow the advertising to be overlaid on top of the video program. This allows minimal storage for advertisements and the advertisement server to interwork with other media server. In the case where the customer is in an airport lounge, hotel room, etc., he can access the inventive advertising and reward media system) via the interne.

It is thus a feature of at least one embodiment of the IFE system 10 to provide for easily and automatically displaying the advertisements on the aircraft's audio visual systems 40, 48.

Still referring to FIG. 2, the IFE system also has a recording system 70 having a storage device such as hard drive 72. The hard drive 72 may be used for storing the recorded information about the passengers, the advertisements presented, and other information. It also has a processor 74 and a memory 76, which may have a stored executable program or other data. The IFE system recording system 70 has one or more devices which receive information comprising the passenger identity, the identity of the advertisement presented to the passenger, the requested act information and the information about the performance of the requested act, and a device 72 for storing said information.

Thus it is also a feature of at least one embodiment of IFE system 10 to provide for recording system 70 that gathers the information about the passengers and their interactions with the advertisements presented by the audio visual system. The information may be stored in hard drive 72 having database 73.

The media server 50, advertisement server 52, and recording system 70 have communication channel 78 that may allow for external computers, such as billing server 80, to communicate as well. The communication channels may be separate channels or may be combined as shown. These communication channels may be wired or wireless, and they may be Ethernet connections or some other computer communications channel such as a parallel data transmission bus.

Furthermore, the system 10 may have a media server and an advertisement server that are integrated thereby minimizing the space and cost of serving audio visual programs and advertising. Alternatively, the servers (e.g., media, advertisement, and recording servers) can be logical servers or programs all residing on a single physical server.

Continuing with FIG. 2, the IFE system also has a billing server 80 which may not be on board the aircraft. The billing server may connect or be connected to multiple aircraft (not shown). The billing server 80 may include a storage device such as hard drive 82.

The billing server hard drive may be used for storing various data in one or more databases 84, including but not limited to: audio programs, video programs, advertisements (either audio or video), information recorded by the recording system, passenger records, and advertisement billing records. The billing server 80 has a processor 86 and a memory 88 which may have an executable program or other data stored within. The billing server 80 has a communication channel 90 for communicating with aircraft 36. This may be wired or wireless.

In one embodiment, the system will also include a data warehouse containing information about the passenger that will be used in directed advertising such as income level, frequency of flying, home address, destinations, previous advertisement selections, etc. Any actions taken on the plane or other locations will be aggregated in the data warehouse for each customer and advertiser.

Additionally, the system will a have a web-based server that can be accessed from any location via the interne.

The IFE system may include determining the passenger identity while still on board the aircraft by at least one of: a passenger's seat number, a passenger's frequent flyer number, a passenger's credit card, a passenger's social security number, a passenger's passport number, a passenger's debit card, a passenger's name, a passenger's flight confirmation number, etc.

It is thus a feature of at least one embodiment of the invention to provide for a variety of ways to identify the passenger while on board, including identification that requires no action on the passenger's part such as the passenger seat assignment. For example, passenger 44 viewing audio visual system 42 is identified by his position in seat 47. She is viewing an advertisement 49 and, as part of a requested act, she has used the controller 46 to purchase some item and been awarded a discount. Acts other than making a purchase while on board may be performed such as accepting the presentation of an audio or video program (including other advertisements), making a reservation, responding to a question or survey, etc. The airline may also acquire revenue from such acts, which may pass an incentive to the passenger as a result.

It is thus a feature of at least one embodiment of the invention to provide for the passenger to perform the requested act while still on board the aircraft, thus tracking the effectiveness of the advertisement while the passenger is on board.

Passenger identity (for example, based on seat number), the advertisement viewed, the requested act, and the completion of requested act may be captured by recording system 70. The recording system 70 may transmit the information to the billing server 80 for assessing a fee to the advertiser. One potential incentive to passenger 38 may be the award of frequent flyer miles.

The IFE system 10 thus allows the collection of passenger identification information, advertisement presentation information, and requested and performed act information, which is available to the billing server 80. This collection of information allows determination of the effectiveness of the advertisements in getting the passengers to perform the requested acts. The system subsequently provides a bill to the advertiser based upon the presentation of the advertisements and the requested acts performed as will be explained below.

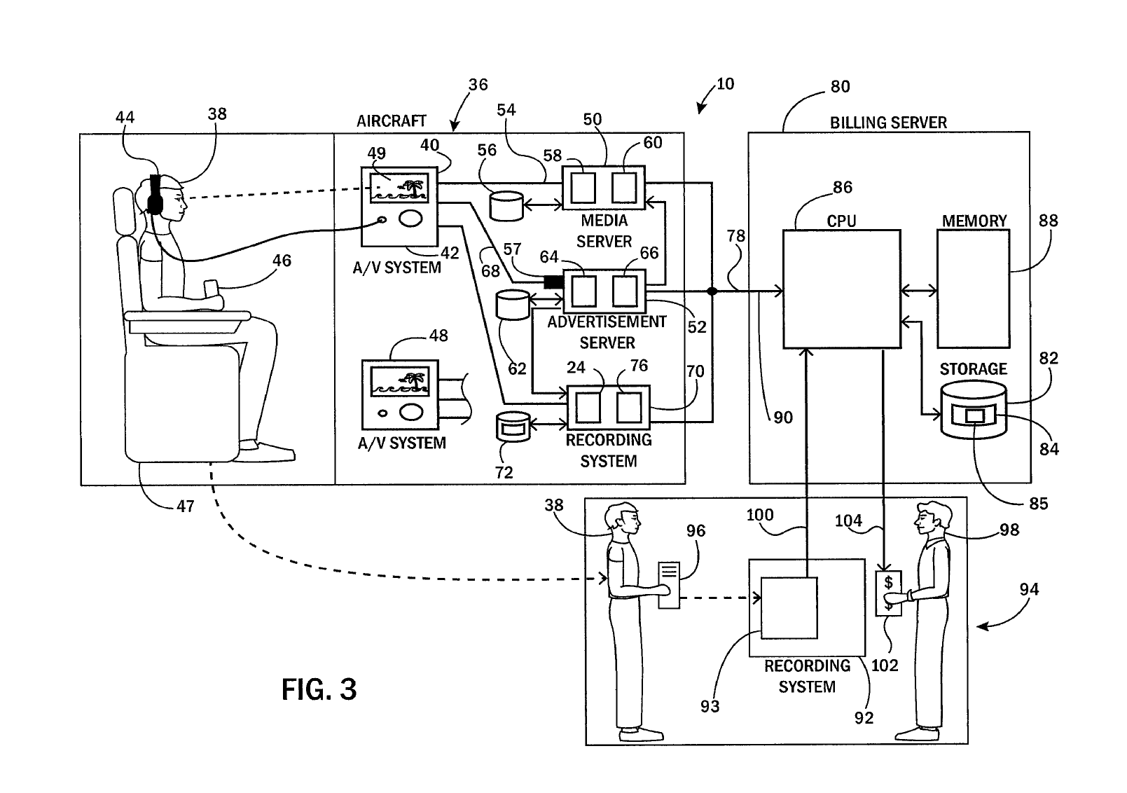

Turning now to FIG. 3, the IFE system embodiment illustrated is substantially the same as the embodiment of FIG. 2. However, the recording system 92 has been added at a location that is subsequently visited, for example, a car dealership, by passenger 38.

The IFE system may include identifying the passenger 38 after they exit the aircraft 36. The identifying means could be a passenger's frequent flyer number, a passenger's flight number, a passenger's credit card, a passenger's debit card, an email address, a coupon, a discount code, a passenger's name, a passenger's flight confirmation number, a number, a word, a phrase, a pictogram, etc.

It is thus another feature of at least one embodiment of the invention to provide for a variety of ways to identify the passenger after deplaning. For example, passenger 38 has an identifying means 96 to use to complete the performance of the requested act. The passenger 38 visits a business at location 94 and presents the identifier such as an emailed or text messaged coupon 96 to a merchant 98. The merchant has a recording system 92 with a receiving device such as keyboard 93 which receives the information on the coupon 96 such as “Discount code: A46.” In this embodiment, the IFE system 10 includes a recording system 92 with device 93 which receives information and is located off the aircraft. This embodiment is in contrast to the example in FIG. 2 wherein the recording system has devices that receive information about the performance of the requested act, which are located on the aircraft. Thus the embodiment of FIG. 2 provides for a completely onboard, compact self-contained recording system, while the embodiment of FIG. 3 provides a distributed recording system that tracks requested events and passengers after they deplane to further determine the effectiveness of the advertisements.

The information on the coupon 96 provided by passenger 38 may be used to identify the passenger or to verify the advertisement that the passenger viewed. This information is provided by the passenger 38 while performing the requested act (i.e. a transaction with the merchant 98 using the coupon 96) and is transmitted to the billing server 80 over communication channel 100 which may identify the advertisement viewed, such as advertisement 28 in FIG. 1. A billing server 80 also may identify the passenger 38, and store the information about the customer performing the requested act (i.e. submitting the coupon 96 for some incentive such as a discount). The information gathered is used by the billing server 80 to generate an advertising bill 102 to merchant 98 over some communication channel 104 such as the Internet. Note that the incentive may be a price discount on a purchase of advertiser goods, a price discount on a purchase of advertiser services, additional frequent flyer miles, customer reward points with the advertiser, a coupon, a gift, a flight upgrade, a bonus, etc.

Moreover, a fee may be assessed by a billing server 80. The billing server 80 preferably has a processor 86, a storage unit 82, and a database 84 therein containing a record 85. The record may include the passenger identity, the identity of the advertisement presented to the passenger, the information about the performance of the requested act, and the fee that is assessed to an advertiser for the advertisement presented when the passenger performs the requested act. The fee provides another revenue stream based on the effectiveness of the advertisements in eliciting a requested act from an airline passenger.

The billing server 80 is in communication with the recording system 70, 92 whereby information is transmitted from the recording system to the billing server (over communication channels 78, 100). The information may include: the passenger identity, the identity of the advertisement presented to the passenger, the requested act information, and the information about the performance of the requested act. Thus, one embodiment of the invention provides a closed loop which provides advertising and generates bills based on advertising effectiveness. This is done so by collecting the information to a centralized billing server 80.

The IFE system 10 also includes information that is transmitted from the recording system to the billing server over communication channels 78, 100. The billing server 80 may request that the information be transmitted from the recording system 92, 70. Alternatively, the billing server 80 may accept autonomous transmission of the information from the recording system 92, 70. This provides the billing server 80 with information that is automatically pushed to the billing server 80, or may be pulled by the billing server 80 either automatically at some preset times or time intervals, or at asynchronous intervals such as when the aircraft 36 is in communication with a computer network.

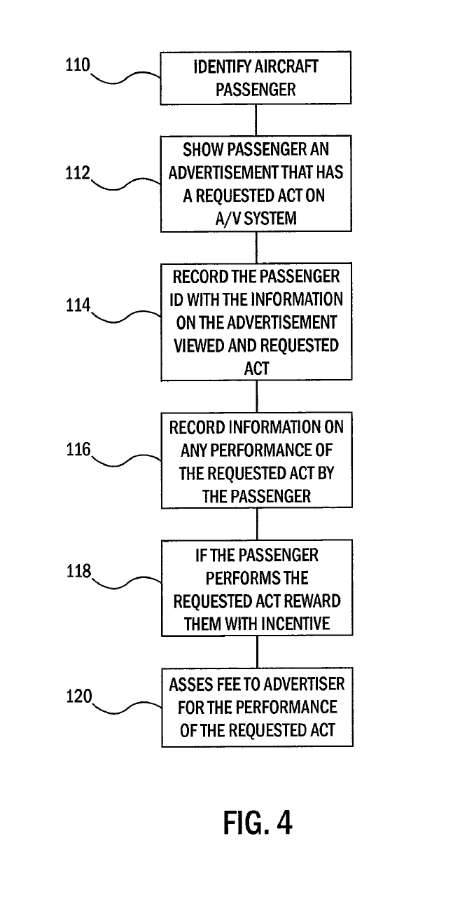

Referring now to FIG. 4, a method of generating additional revenue with an IFE system is shown as a flow chart. The method identifies a passenger on an aircraft 110. The passenger is presented an advertisement which contains a requested act for the passenger to perform 112. The system ensures identification of the passenger along with the presented advertisement and the requested act 114. The system 10 records this information along with any performance of the requested act 116 and preferably rewards the passenger with an incentive if she performs the requested act 118. An additional fee is then assessed to the advertiser for the performance of the requested act 120, e.g., staying at the advertised hotel, renting the advertised car, or buying the advertised product.

Thus, the present invention also provides a method for generating additional revenue with an IFE system. This method includes identifying a passenger on an aircraft and presenting an advertisement to the passenger along with a video or audio program, wherein the advertisement contains a requested act for the passenger to perform. The passenger is identified along with the presented advertisement, the requested act, and performance of the requested act. The passenger is provided an incentive to perform the requested act. Finally, a fee is assessed to the advertiser for the performance of the requested act. Additional fees may be assessed if the passenger engages in subsequent transactions. For example, if the passenger becomes a preferred customer by performing a requested act, then subsequent transactions with the advertiser may generate fees payable to the airline.

It is thus a feature of at least one embodiment of the invention to provide a method of generating more revenue and encouraging the passenger to perform the requested act to gain an incentive, thus, improving the effectiveness of the advertising, improving passenger satisfaction, and providing a revenue stream for the airline and/or to offset the cost of the IFE system and the associated content of the audio and visual programs.

In one embodiment, it is preferred to provide a mechanism at the point of sale, such a card swipe reader, a bar code reader, a QR code, or similar device to allow users to easily access the system and the system to capture user data, such as name, ID number, etc. This will also allow for a quick and effective way for the system to reward the user and/or redeem rewards.

The inventive system 10 can be tied into existing IFE systems that are currently on board aircraft, such those supplied by Panasonic Avionics Corporation, Thales Group, Rockwell Collins, and LiveTV for Airbus and Boeing aircraft. Alternatively, the inventive system may be linked with systems provided by Thompson Aerospace, e.g., 1NET and include those described in U.S. Patent Publication Nos. 20100199196 and 20100195634 which are herein expressly incorporated by reference.

Various alternatives and modifications are contemplated as being within the scope of the following claims particularly pointing out and distinctly claiming the subject matter regarded as the invention. For example, the inventor envisions a similar system 10 may be used by passengers in a taxi, ship, bus, or a train while viewing audio visual systems or being delivered wirelessly via laptops, smart phones, I-Pads®, etc. . As well, other applications such as audio visual systems in airport lounges, hotels, in a lobby, terminal, casinos, and so forth are envisioned. Again, such a system is viable anywhere access to the following basic hardware components is possible:
A wireless local area network (WLAN) composed of wireless access points (typically a IEEE 802.11 g/n system) which are used to provide access to network devices (laptops, smartphones, tablets, etc).
A wired network switch and router which provide connections from the wireless access points to the media content servers (allowing the customers to view content) or to the internet (out side of the aircraft).
Media content/web servers, database servers, billing servers which connect via wired Ethernet to the network in order to server media content (video and or audio), track user data and interactions and create both billing and advertising reports for the advertisers and the system supplier.

As can be appreciated, the above systems will essentially be the same whether in an aircraft, airport, lounge, hotel room, or any other location where the inventive system's software is accessible. Not all of the above components need to necessarily be part of a standalone IFE system as they might already exist in the aircraft/lounge/hotel room etc., and the inventive system would merely use them as a way of connecting to its servers. Further, not all of the components need to necessarily be on the aircraft such as the billing server.

As can be appreciated, many changes and modifications could be made to the invention without departing from the spirit thereof. The scope of these changes will become apparent from the appended claims.

What is claimed is:

1. An IFE system comprising:
an audio visual system comprising a video device for presentation of a video program and an audio device for presentation of an audio program;
a control for choosing the video and audio programs for presentation to a passenger;
an advertisement presented to the passenger along with the presentation of the chosen audio or video program;
a media server having a processor and a storage unit containing the audio and video programs;
a communication channel for transmitting the audio and video programs from the media server to the audio visual system;
a data warehouse capturing all information about the customer a requested act presented in the advertisement to be performed by the passenger; and
a recording system that captures a record comprising the passenger identity, the identity of the advertisement presented to the passenger, the requested act information, and the information about the performance of the requested act; and
a database having the record.

2. The IFE system of claim 1 further comprising a fee that is assessed to an advertiser for the advertisement presented when the passenger performs the requested act.

3. The IFE system of claim 2 further comprising an incentive given to the passenger who is presented the advertisement and performs the requested act.

4. The IFE system of claim I wherein the requested act comprises the passenger presenting identifying information in the performance of a post-deplaning requested act; and wherein the audio visual system is on a wireless device connected to a wireless network on board an aircraft.

5. The IFE system of claim 4 wherein the post-deplaning requested act which comprises identifying the passenger and wherein the identifying means is one from a group consisting a passenger's frequent flyer number, a passenger's flight number, a passenger's credit card, a passenger's debit card, a coupon, a discount code, a passenger's name, a passenger's flight confirmation number, an ID code, a number, a word, a phrase, email address and a pictogram.

6. The IFE system of claim 1 wherein the requested act is performed by the passenger predeplaning.

7. The IFE system of claim 6 wherein the passenger identity is determined by at least one of a passenger's seat number, a passenger's frequent flyer number, a passenger's credit card, a passenger's social security number, a passenger's passport number, a passenger's debit card, a passenger's name, and a passenger's flight confirmation number.

8. The IFE system of claim 6 wherein the requested act is at least one of accepting the presentation of an audio or video program, making a reservation, making a purchase, and responding to a question.

9. The IFE system of claim 1 wherein the audio-visual system is one or more selected from a group consisting of a projector, a television, a personal video screen, a personal computer, a laptop, a smart phone, and a portable media player.

10. The IFE system of claim 1 wherein the recording system comprises one or more devices which receive information comprising the passenger identity, the identity of the advertisement presented to the passenger, the requested act information and the information about the performance of the requested act and a device for storing said information.

11. The IFE system of claim 1 wherein the advertisement is stored on an advertisement server having a processor, storage unit, and a communication channel for transmitting the advertisement from the advertisement server to the audio visual system.

12. The IFE system of claim 11 wherein the media server and advertisement server are integrated; and wherein the recording system devices that receive information about the performance of the requested act are located off the aircraft.

13. The IFE system of claim 11 wherein the advertisement server further comprises a device for insertion of the advertising during, substantially around, or within the presentation of the selected audio or video program.

14. The IFE system of claim 11 wherein the advertisement server further comprises a control for the presentation video and audio programs of the media server.

15. The IFE system of claim 10 wherein the recording system devices that receive information are located on the aircraft.

16. The IFE system of claim 2 wherein the fee is assessed by a billing server having a processor, a storage unit, and a database therein containing a record with the record comprising the passenger identity, the identity of the advertisement presented to the passenger, the information about the performance of the requested act, and the fee that is assessed to an advertiser for the advertisement presented when the passenger performs the requested act.

17. The IFE system of claim 16 wherein the billing server is in communication with the recording system whereby information is transmitted from the recording system to the billing server, said information comprising one or more from a group consisting of the passenger identity, the identity of the advertisement presented to the passenger, the requested act information, and the information about the performance of the requested act.

18. The IFE system of claim 17 wherein the information transmitted from the recording system to the billing server by requesting that it be transmitted from the recording system or by accepting autonomous transmission of the information from the recording system at some preset time or times or asynchronously.

19. The IFE system of claim 2 where the incentive is one or more from a group consisting of a price discount on a purchase of advertiser goods, a price discount on a purchase of advertiser services, additional frequent flyer miles, customer reward points with advertiser, a coupon, a gift, a flight upgrade, and a bonus.

20. A method of generating additional revenue with a system comprising steps of:
identifying a passenger;
presenting an advertisement to the passenger along with an video or audio program, wherein the advertisement contains a requested act for the passenger to perform;
identifying the passenger along with the presented advertisement, the requested act, and performance of the requested act;
providing an incentive for the passenger to perform the requested act; and
assessing a fee to the advertiser for the performance of the requested act.
